(19) United States
(12) Patent Application Publication
(10) Pub. No.: US 2026/0367484 A1
(43) Pub. Date: Nov. 19, 2026

(54) CAMERA ACTUATOR AND CAMERA MODULE INCLUDING SAME

(71) Applicant: LG INNOTEK CO., LTD., Seoul (KR)

(72) Inventor: Sung Guk LEE, Seoul (KR)

(73) Assignee: LG INNOTEK CO., LTD., Seoul (KR)

(21) Appl. No.: 19/142,764

(22) PCT Filed: Jan. 15, 2024
(86) PCT No.: PCT/KR2024/000681

§ 371 Date: Jun. 24, 2025

(30) Foreign Application Priority Data
Jan. 19, 2023 (KR) 10-2023-0007921

(51) Int. Cl. G03B 13/36; G03B 5/00

(52) U.S. Cl. CPC G03B 13/36; G03B 5/00; G03B 2205/0007

(57) ABSTRACT

Disclosed is a camera actuator comprising: a housing; a bobbin that moves inside the housing in the optical axis direction and includes an accommodation hole and first and second side surfaces arranged on opposite sides of the accommodation hole in a direction perpendicular to the optical axis direction; a driving unit that moves the bobbin and includes a magnet disposed on the first side surface of the bobbin and a coil facing the magnet; a magnetic body that is provided in the housing and located at a position corresponding to the magnet; and balls arranged on the second side surface of the bobbin. The balls are pressed between the second side surface of the bobbin and the housing due to the repulsive force generated by the magnetic body and the magnet.

### TECHNICAL FIELD

The present invention relates to a camera actuator and a camera module including the same.

### BACKGROUND ART

Cameras are devices for taking pictures or videos by capturing images of subjects and are mounted on mobile devices, drones, vehicles, etc. To improve the quality of an image, a camera module may have an image stabilizer (IS) function for correcting or preventing an image shake caused by the movement of a user, an auto focusing (AF) function for aligning a focal length of a lens by automatically adjusting an interval between an image sensor and the lens, and a zooming function for capturing an image of a remote subject by increasing or decreasing the magnification of the image of the remote subject through a zoom lens.

However, it is difficult to reduce the weight as a location of a lens assembly is maintained by a force of a yoke in the camera module. Furthermore, there is a continuous demand for miniaturization by reducing a height.

### DETAILED DESCRIPTION OF INVENTION

### Technical Problem

Embodiments of the present invention are directed to providing a camera actuator and a camera module which provide a holding force by generating a repulsive force through a magnet and a magnetic body without a separate magnet or yoke.

In addition, embodiments of the present invention are directed to providing a camera actuator and a camera module of which miniaturization is possible through a ball disposed on a side surface.

In addition, embodiments of the present invention are directed to providing a camera actuator and a camera module of which driving efficiency is increased through locations or shapes of a magnetic body, a magnet, and a coil that generate a repulsive force.

Embodiments of the present invention are also directed to providing a camera actuator applicable to ultra-slim, ultra-small, and high-resolution cameras.

Objects of embodiments are not limited thereto and may also include objects or effects that may be identified from the configurations or embodiments to be described below.

### Technical Solution

A camera actuator according to an embodiment of the present invention includes a housing, a bobbin that moves in an optical axis direction within the housing and includes an accommodation hole and a first side surface and a second side surface disposed opposite to each other with respect to the accommodation hole in a direction perpendicular to the optical axis direction, a driving unit that includes a magnet disposed on the first side surface of the bobbin and a coil facing the magnet and moves the bobbin, a magnetic body disposed in the housing and disposed at a location corresponding to the magnet, and a ball disposed on the second side surface of the bobbin, wherein the ball is pressed between the second side surface of the bobbin and the housing by a repulsive force generated by the magnetic body and the magnet.

The magnet may be accommodated in a first groove of the first side surface, the ball may be accommodated in a second groove of the second side surface, and the first groove may overlap the second groove in a direction perpendicular to the optical axis direction.

The housing may include a first housing side portion and a second housing side portion facing the first housing side portion, an inner surface of the first housing side portion may face the second side surface, and an inner surface of the second housing side portion may face the first side surface.

The housing may include a guide groove disposed on the inner surface of the first housing side portion, and the ball may be disposed in the guide groove.

The second housing side portion may include a coil accommodation hole and a magnetic body groove disposed to be spaced apart from the coil accommodation hole in the optical axis direction, and the magnetic body may be disposed in the magnetic body groove.

The magnetic body groove may be disposed in an outer surface of the second housing side portion.

The magnet may include a first area, a neutral area, and a second area disposed sequentially in the optical axis direction.

The magnetic body may include a first magnetic body adjacent to the first area and a second magnetic body adjacent to the second area.

In the first area, a pole of the outer surface and a pole of the inner surface of the first magnetic body may be the same, and in the second area, the pole of the outer surface and a pole of the inner surface of the second magnetic body may be the same.

The coil may be disposed between the first magnetic body and the second magnetic body.

The coil may include a coil hole, and a length of the coil hole may be greater than a length of the neutral area.

A length of the first area or the second area may be smaller than a length of the coil.

The neutral area may overlap one of the magnetic bodies in a direction perpendicular to the optical axis direction.

When the magnet is moved to one side as much as possible, the first magnetic body may not overlap the second area in a direction perpendicular to the optical axis direction.

When the magnet is moved to the other side as much as possible, the second magnetic body may not overlap the first area in a direction perpendicular to the optical axis direction.

The magnetic body may be spaced apart from the coil in the optical axis direction, and the magnetic body may overlap the coil in the optical axis direction.

The bobbin may be pressed by a repulsive force generated by the magnetic body and the magnet in a direction from the first side surface toward the second side surface perpendicular to the optical axis direction.

A camera actuator according to an embodiment includes a housing, a bobbin disposed in the housing and including a first side surface and a second side surface disposed opposite to each other, a driving unit that includes a coil and a magnet facing each other in one direction perpendicular to an optical axis direction and moves the bobbin in the optical axis direction, a magnetic body disposed in the housing and overlapping at least one area of the magnet in the one direction, and a ball disposed between the housing and the first side surface of the bobbin, wherein the magnet is disposed on the second side surface of the bobbin, and the ball is disposed to overlap the magnet in the one direction.

One surface of the at least one area of the magnet and one surface of the magnetic body may face each other and have the same pole.

A camera actuator according to an embodiment includes a housing, a bobbin disposed in the housing, a driving unit that includes a coil and a magnet and moves the bobbin in an optical axis direction, a ball disposed between the housing and the bobbin, and a first magnetic body and a second magnetic body disposed in the housing, generates a repulsive force with the magnet, and spaced apart from each other in the optical axis direction, wherein the magnet is disposed on one surface of the bobbin, the coil, the first magnetic body, and the second magnetic body are disposed on one side portion of the housing facing the one side surface, and at least a portion of the coil is disposed between the first magnetic body and the second magnetic body.

### Advantageous Effects

According to embodiments of the present invention, it is possible to implement a camera actuator and a camera module which provide a holding force by generating a repulsive force through a magnet and a magnetic body without a separate magnet or yoke.

In addition, according to embodiments of the present invention, it is possible to implement a camera actuator and a camera module of which miniaturization is possible through a ball disposed on a side surface.

In addition, according to embodiments of the present invention, it is possible to implement a camera actuator and a camera module of which driving efficiency is increased through locations or shapes of a magnetic body, a magnet, and a coil that generate a repulsive force.

According to embodiments of the present invention, it is possible to provide a camera actuator applicable to ultra-slim, ultra-small, and high-resolution cameras.

Various and beneficial advantages and effects of the present invention are not limited to the above-described contents and will be more readily understood during a process of describing specific embodiments of the present invention.

### DESCRIPTION OF DRAWINGS

FIG. 1 is a perspective view of a camera module according to an embodiment.

FIG. 2 is an exploded perspective view of the camera module according to the embodiment.

FIG. 3 is a view along line AA′ in FIG. 1.

FIG. 4 is a perspective view of a second camera actuator according to the embodiment.

FIG. 5 is an exploded perspective view of the second camera actuator according to the embodiment.

FIG. 6 is a perspective view of a housing of the second camera actuator according to the embodiment.

FIG. 7 is a perspective view of a lens assembly in the second camera actuator according to the embodiment.

FIG. 8 is a perspective view of a driving unit, a substrate, and a magnetic body in the second camera actuator according to the embodiment.

FIG. 9 is a view along line DD′ in FIG. 4.

FIG. 10 is a perspective view of FIG. 9.

FIG. 11 is a view of a lens assembly disposed at a specific location in the second camera actuator according to the embodiment.

FIG. 12 is a view of a lens assembly disposed at another specific location in the second camera actuator according to the embodiment.

FIG. 13 is a view of a lens assembly disposed in a first state in the second camera actuator according to the embodiment.

FIG. 14 is a view of a lens assembly disposed in a second state in the second camera actuator according to the embodiment.

FIG. 15 is a schematic view illustrating a circuit board according to the embodiment.

FIG. 16 is a perspective view of a mobile terminal to which the camera module according to the embodiment is applied.

FIG. 17 is a perspective view of a vehicle to which the camera module according to the embodiment is applied.

### MODES OF THE INVENTION

Since the present invention may have various changes and various embodiments, specific embodiments are illustrated and described in the accompanying drawings. However, it should be understood that it is not intended to limit specific embodiments, and it should be understood to include all modifications, equivalents, and substitutes included in the spirit and scope of the present invention.

Terms including ordinal numbers such as second or first may be used to describe various components, but the components are not limited by the terms. The terms are used only for the purpose of distinguishing one component from another. For example, a second component may be referred to as a first component, and similarly, the first component may also be referred to as the second component without departing from the scope of the present invention. The term “and/or” includes a combination of a plurality of related listed items or any of the plurality of related listed items.

When a first component is described as being “connected” or “coupled” to a second component, it should be understood that the first component may be directly connected or coupled to the second component or a third component may be present therebetween. On the other hand, when a certain component is described as being “directly connected” or “directly coupled” to another component, it should be understood that still another component is not present therebetween.

Terms used in the present application are only used to describe specific embodiments and are not intended to limit the present invention. The singular includes the plural unless the context clearly dictates otherwise. In the application, it should be understood that terms “include” and “have” are intended to specify that a feature, a number, a step, an operation, a component, a part, or a combination thereof described in the specification is present, but do not preclude the possibility of the presence or addition of one or more other features, numbers, steps, operations, components, parts, or combinations thereof.

Unless defined otherwise, all terms used herein, including technical or scientific terms, have the same meaning as commonly understood by those skilled in the art to which the present invention pertains. Terms such as those defined in a commonly used dictionary should be construed as having a meaning consistent with the meaning in the context of the related art and should not be construed in an ideal or excessively formal meaning unless explicitly defined in the application.

Hereinafter, embodiments will be described in detail with reference to the accompanying drawings, and the same or corresponding components are denoted by the same reference numeral regardless of the reference numerals, and overlapping descriptions thereof will be omitted.

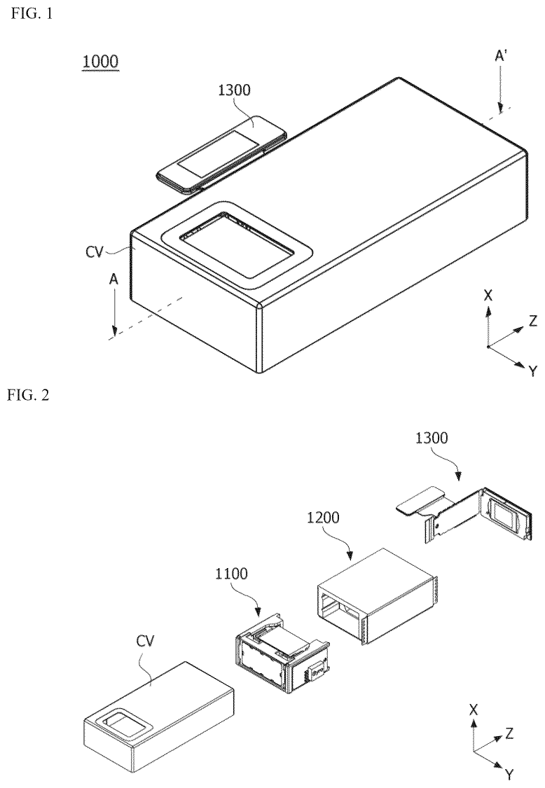

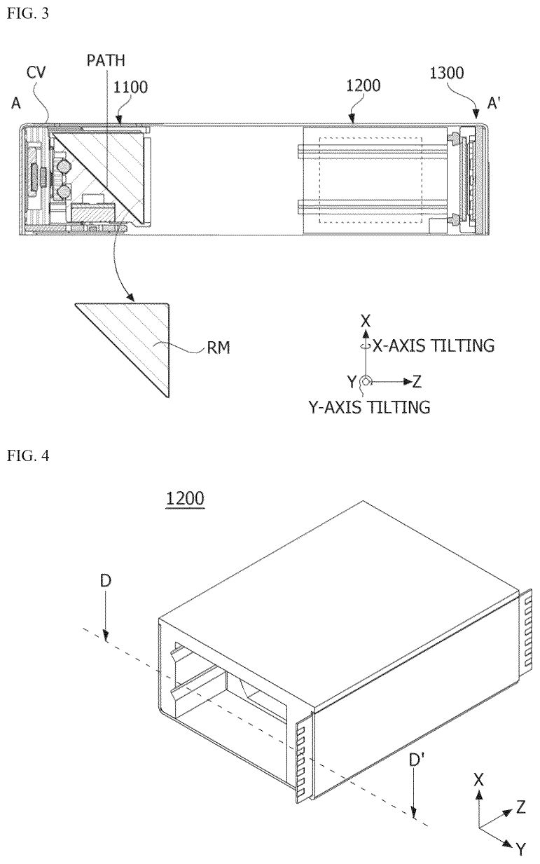

FIG. 1 is a perspective view of a camera module according to an embodiment, FIG. 2 is an exploded perspective view of the camera module according to the embodiment, and FIG. 3 is a view along line AA′ in FIG. 1.

Referring to FIGS. 1 and 2, a camera module 1000 according to the embodiment may include a cover CV, a first camera actuator 1100, a second camera actuator 1200, and a circuit board 1300. Here, the first camera actuator 1100 may be used interchangeably with a “first actuator,” and the second camera actuator 1200 may be used interchangeably with a “second actuator.”

The cover CV may cover the first camera actuator 1100 and the second camera actuator 1200. It is possible to increase a coupling force between the first camera actuator 1100 and the second camera actuator 1200 by the cover CV.

Furthermore, the cover CV may be formed of a material that blocks electromagnetic waves. Accordingly, it is possible to easily protect the first camera actuator 1100 and the second camera actuator 1200 in the cover CV.

In addition, the first camera actuator 1100 may be an optical image stabilizer (OIS) actuator. For example, the first camera actuator 1100 may move an optical member in a direction perpendicular to the optical axis (axis of incident light).

The first camera actuator 1100 may include a fixed focal length lens disposed in a predetermined barrel (not illustrated). The fixed focal length lens may be referred to as “single focal length lens” or “single lens.”

The first camera actuator 1100 may change an optical path. In an embodiment, the first camera actuator 1100 may vertically change the optical path through an internal optical member (e.g., a prism or a mirror). For example, the optical member may change light from a first direction (an X-axis direction) to a third direction (a Z-axis direction). Alternatively, the optical member may change the light from a first axis to a second axis. With this configuration, even when a thickness of a mobile terminal is decreased, a lens with a focal length that is greater than the thickness of the mobile terminal is disposed in the mobile terminal through a change in the optical path so that magnification and auto focusing (AF), zooming, and OIS functions may be performed.

However, the embodiments of the present invention are not limited thereto, and the first camera actuator 1100 may change the optical path vertically or at a predetermined angle multiple times.

The second camera actuator 1200 may be disposed behind the first camera actuator 1100. The second camera actuator 1200 may be coupled to the first camera actuator 1100. In addition, mutual coupling may be performed by various methods.

In addition, the second camera actuator 1200 may be a zoom actuator or an AF actuator. For example, the second camera actuator 1200 may support one lens or a plurality of lenses and perform an AF function or a zooming function by moving the lenses according to a predetermined control signal of a control unit.

In addition, one lens or a plurality of lenses may independently or individually move in the optical axis direction.

The circuit board 1300 may be disposed behind the second camera actuator 1200. The circuit board 1300 may be electrically connected to the second camera actuator 1200 and the first camera actuator 1100. In addition, the circuit board 1300 may be provided as a plurality of circuit boards.

A camera module according to the embodiment may be formed of one camera module or a plurality of camera modules. For example, the plurality of camera modules may include a first camera module and a second camera module.

In addition, the first camera module may include one actuator or a plurality of actuators. For example, the first camera module may include the first camera actuator 1100 and the second camera actuator 1200.

In addition, the second camera module may include an actuator (not illustrated) that is disposed in a predetermined housing (not illustrated) and may drive a lens part. The actuator may be a voice coil motor, a micro actuator, a silicone actuator, etc. and applied in various methods, such as an electrostatic method, a thermal method, a bimorph method, an electrostatic force method, etc., but is not limited thereto. In addition, in the present specification, the camera actuator may be referred to as “actuator” or the like. In addition, the camera module formed of the plurality of camera modules may be mounted in various electronic devices, such as a mobile terminal. Furthermore, the actuator may be a device for moving or tilting the lens or the optical member. However, the actuator will be described below as including the lens or the optical member. Furthermore, the actuator may be referred to as “lens transfer device,” “lens moving device,” “optical member transfer device,” “optical member moving device,” etc.

Referring to FIG. 3, the camera module according to the embodiment may include the first camera actuator 1100 for performing an OIS function and the second camera actuator 1200 for performing a zooming function and an AF function.

Light may enter the camera module or the first camera actuator through an opening area located at an upper surface of the first camera actuator 1100. That is, the light may primarily enter the first camera actuator 1100 in a vertical direction (e.g., an X-axis direction, based on incident light), and the optical path may be changed in an optical axis direction (e.g., a Z-axis direction) through the optical member. In addition, the light may pass through the second camera actuator 1200 and may be incident on an image sensor IS located at one end of the second camera actuator 1200 (PATH). In the present specification, the Z-axis direction or a third direction will be described as the optical axis direction below. In addition, the first direction and the X-axis direction will be described as the vertical direction. In addition, a second direction and a Y-axis direction will be described as a horizontal direction.

In the present specification, a lower surface refers to one side in a first direction. In addition, the first direction is the X-axis direction in the drawings and may be used interchangeably with a second axis direction. A second direction is a Y-axis direction in the drawings and may be used interchangeably with a first axis direction. The second direction is a direction perpendicular to the first direction. In addition, the third direction is the Z-axis direction in the drawings and may be used interchangeably with a third axis direction. In addition, the third direction is a direction perpendicular to both the first direction and the second direction. Here, the third direction (the Z-axis direction) corresponds to the optical axis direction, and the first direction (the X-axis direction) and the second direction (the Y-axis direction) are directions perpendicular to the optical axis. In addition, hereinafter, the optical axis direction is the third direction (Z-axis direction) in the description of the first and second camera actuators, and based on the above description, the following description will be given.

In addition, in the present specification, “inside” may be a direction from the cover CV to the first camera actuator, and “outside” may be a direction opposite to “inside.” That is, the first camera actuator and the second camera actuator may be located inside the cover CV, and the cover CV may be located outside the first camera actuator or the second camera actuator.

In addition, with this configuration, the camera module according to the embodiment may resolve the spatial limitations of the first camera actuator and the second camera actuator by changing the optical path. That is, the camera module according to the embodiment may extend the optical path while minimizing the thickness of the camera module in response to the change in the optical path. Furthermore, it should be understood that the second camera actuator may provide a high range of magnification by controlling a focus in the extended optical path.

In addition, the camera module according to the embodiment may implement an OIS by controlling the optical path through the first camera actuator, thereby minimizing the occurrence of a decentering or tilting phenomenon and providing the best optical characteristics.

Furthermore, the second camera actuator 1200 may include an optical system and a lens driving unit. For example, at least one of a first lens assembly, a second lens assembly, and a third lens assembly may be disposed in the second camera actuator 1200.

In addition, the second camera actuator 1200 may include a coil and a magnet and perform a high-magnification zooming function and the AF function.

For example, although the first lens assembly and the second lens assembly may be moving lenses that move through the coil, the magnet, and a guide pin and the third lens assembly may be a fixed lens, the embodiments of the present invention are not limited thereto. For example, the third lens assembly may perform a function of a focator using which light forms an image at a specific location, and the first lens assembly may perform a function of a variator for re-forming an image formed by the third lens assembly, which is the focator, at another location. Meanwhile, the first lens assembly may be in a state in which a magnification change is large because a distance to a subject or an image distance is greatly changed, and the first lens assembly, which is the variator, may play an important role in a focal length or magnification change of the optical system. Meanwhile, imaging points of an image formed by the first lens assembly, which is the variator, may be slightly different depending on a location thereof. Accordingly, the second lens assembly may perform a location compensation function for the image formed by the variator. For example, the second lens assembly may perform a function of a compensator for accurately forming an image at an actual location of the image sensor using the imaging points of the image formed by the first lens assembly which is the variator. For example, the first lens assembly and the second lens assembly may be driven by an electromagnetic force generated by the interaction between the coil and the magnet. The above description may be applied to a lens assembly to be described below. In addition, the first lens assembly to the third lens assembly may move in the optical axis direction, that is, in the third direction. In addition, the first lens assembly to the third lens assembly may move in the third direction independently or dependently. In the present invention, the first lens assembly and the second lens assembly may move in the optical axis direction. In addition, the third lens assembly may be located in front of the first lens assembly or behind the second lens assembly. In addition, the third lens assembly may not move in the optical axis direction. That is, the third lens assembly may be a fixed part. In addition, the first and second lens assemblies may be moving parts.

Meanwhile, when the OIS actuator and the AF/zoom actuator are disposed according to the embodiment of the present invention, the magnetic field interference with AF/zoom magnets can be prevented when the OIS is driven. Since a first driving magnet of the first camera actuator 1100 is disposed separately from the second camera actuator 1200, it is possible to prevent the magnetic interference between the first camera actuator 1100 and the second camera actuator 1200. In the present specification, an OIS may be used interchangeably with terms such as hand shaking correction, optical image stabilization, optical image correction, shaking correction, etc.

In particular, an optical member RM in the first camera actuator 1100 may tilt along an X-axis or a Y-axis. Accordingly, the optical path can be easily changed according to the X-axis tilting or the Y-axis tilting.

The optical member RM may be seated on a holder of the first camera actuator or the like. In an embodiment, the optical member RM may be formed of a mirror or a prism. Hereinafter, the optical member 1132 is illustrated as being a prism but may be formed of a plurality of lenses as in the above embodiment. Alternatively, the optical member RM may be formed of the plurality of lenses and the prism or the mirror. In addition, the optical member RM may include a reflector disposed therein. However, the embodiments of the present invention are not limited thereto.

The optical member RM in the first camera actuator 1100 may tilt along an X-axis or a Y-axis by the driving of a VCM or the like. That is, the OIS may be implemented by tilting or rotating the optical member RM in the Y-axis direction or the X-axis direction.

The first camera actuator 110 may reflect light incident in the first direction (the X-axis direction) using the optical member RM in the third direction (the Z-axis direction) perpendicular to the first direction. In addition, the second camera actuator to be described below may receive reflected light.

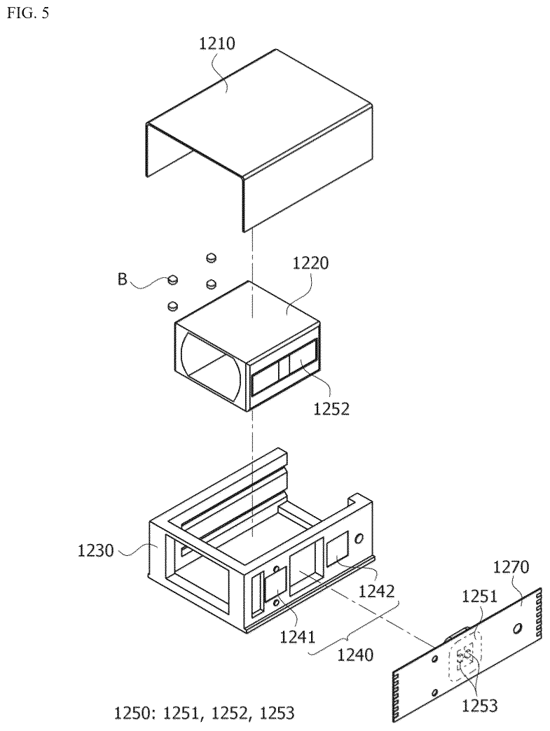

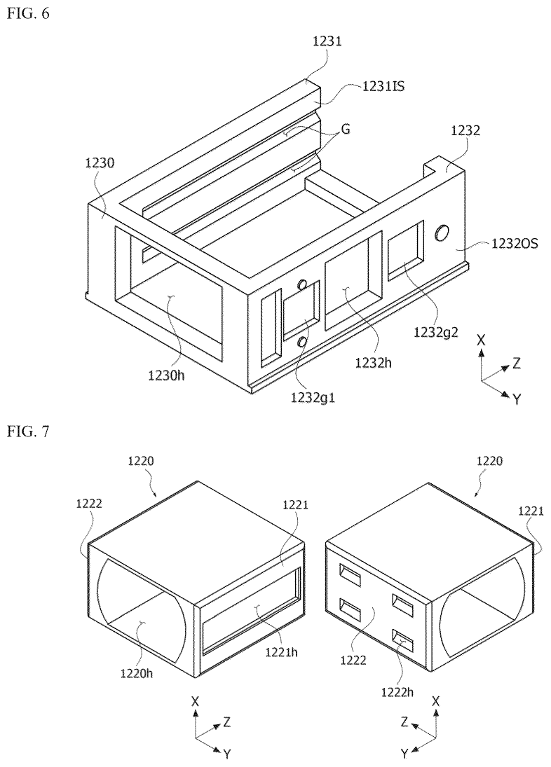

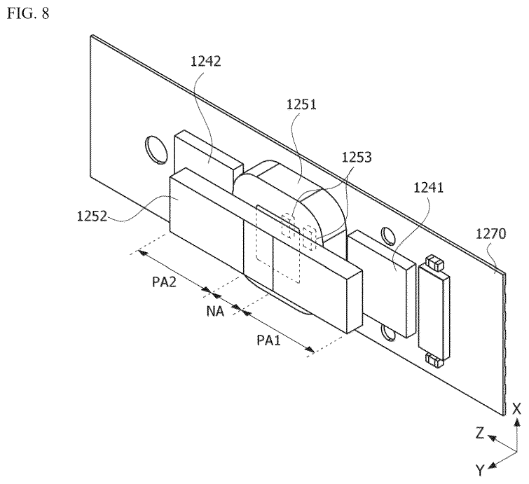

FIG. 4 is a perspective view of a second camera actuator according to the embodiment, FIG. 5 is an exploded perspective view of the second camera actuator according to the embodiment, FIG. 6 is a perspective view of a housing of the second camera actuator according to the embodiment, FIG. 7 is a perspective view of a lens assembly in the second camera actuator according to the embodiment, and FIG. 8 is a perspective view of a driving unit, a substrate, and a magnetic body in the second camera actuator according to the embodiment.

Referring to FIGS. 4 and 5, the second camera actuator 1200 (or a camera device, a zoom lens transport device, a zoom lens moving device, or a lens transport device) according to the embodiment may include a shield can 1210, a lens assembly 1220, a housing 1230, a magnetic body 1240, a driving unit 1250, a base part 1260, a substrate 1270, and balls B. Furthermore, the second camera actuator 1200 may further include an elastic part (not illustrated) and a bonding member (not illustrated). The elastic part may perform shock relief between lenses or shock relief or a stopper of the lens assembly. The bonding member may be in contact with a specific component so that various components are coupled.

In addition, as will be described below, the lens assembly 1220 may include a lens group composed of at least one lens. The lens assembly 1220 may be referred to as a lens holder, a bobbin, a lens accommodation member, a lens transport member, etc. The lens assembly 1220 (the lens group) may move in the optical axis direction. In this case, the second camera actuator may include a moving part that moves in the optical axis direction like the lens group, and a fixed part relatively fixed without moving in the optical axis direction unlike the moving part. In the present embodiment, the moving part may include a lens assembly and a magnet. In addition, the fixed part may include a housing, a substrate, a coil, and a Hall sensor. Furthermore, a driving magnet may be disposed on one of the moving part and the fixed part, and a driving coil may be disposed on the other. A movement distance of the lens assembly to be described below corresponding to such description may correspond to a movement distance of the moving part.

The shield can 1210 may be located at one area (e.g., an outermost edge) of the second camera actuator 1200. In addition, the shield can 1210 may be located to surround various components (the lens assembly 1220, the housing 1230, the magnetic body 1240, the driving unit 1250, the base part 1260, and substrate 1270).

The shield can 1210 can block or reduce electromagnetic waves generated from the outside. Accordingly, it is possible to reduce the occurrence of a malfunction of the driving unit 1250.

The lens assembly 1220 may move in the optical axis direction. The lens assembly 1220 may be located at the shield can 1210 and the housing 1230. A zoom or AF function may be performed by moving the lens assembly 1220. For example, the zoom function may be performed by moving the lens assembly 1220. The lens assembly 1220 may be composed of at least one moving group. The lens assembly 1220 may move in the third direction or the optical axis direction by a force (e.g., an electromagnetic force) generated by the driving unit 1250.

The housing 1230 may surround the lens assembly 1220. The housing 1230 may be located between the lens assembly 1220 and the shield can 1210. For example, the housing 1230 may have a greater length in the optical axis direction than a length in a horizontal direction. In addition, the housing 1230 may have a width in the second direction (the Y-axis direction) greater than a height in the first direction (the X-axis direction). Accordingly, the compactness of the second camera actuator and the camera module can be achieved.

The housing 1230 may be referred to as a “main barrel,” a “lens barrel,” a “barrel,” etc.

Referring again to FIG. 6, the housing 1230 may include a housing hole 1230h. Light provided from the first camera actuator through the housing hole 1230h may be provided to the image sensor after passing through the lens group of the lens assembly 1220.

In addition, the housing 1230 may include a first housing side portion 1231 and a second housing side portion 1232. The first housing side portion 1231 and the second housing side portion 1232 may be disposed to be spaced apart from each other in the horizontal direction. In addition, the first housing side portion 1231 and the second housing side portion 1232 may be disposed to face each other. For example, the first housing side portion 1231 and the second housing side portion 1232 may be disposed symmetrically with respect to an optical axis.

In addition, the housing 1230 may include a guide groove G in an inner side portion of the housing. In addition, the housing side portion of the housing 1230 may include a coil accommodation hole 1232h and magnetic body grooves 1232g1 and 1232g2.

For example, the first housing side portion 1231 may include the guide groove G. A ball B may be seated in the guide groove G. Accordingly, the ball B may roll or slip along the guide groove G so that the lens assembly 1220 may move in the optical axis direction. For example, the guide groove G may be a rail. In addition, the guide groove G may be located at an inner side 1231IS of the first housing side portion 1231.

In addition, the balls B may be located at a side portion rather than an upper or lower surface of the housing. In addition, the balls B may be disposed between the lens assembly 1220 and the housing 1230. Furthermore, the balls B may be disposed between a second side surface 1222 of the lens assembly 1220 and the first housing side portion of the housing 1230. Accordingly, the second camera actuator can have a minimized length in the first direction or the vertical direction. Accordingly, it is possible to miniaturize the camera actuator.

In addition, the inner side surface 1231IS of the first housing side portion 1231 may face the second side surface of the lens assembly 1220 to be described below. In addition, the guide groove G may face the second side surface of the lens assembly 1220. In particular, the guide groove G may face a recess 1222h of the lens assembly 1220. For example, the guide groove G may overlap the recess 1222h in the optical axis direction.

In addition, at least a portion of the guide groove G may overlap a magnet 1252 located at a first side surface 1221 in the horizontal direction. At least a portion of the ball B may also overlap the magnet 1252 located at the first side surface 1221 in the horizontal direction. With this configuration, to provide a pressing force to the ball B accommodated in the second side surface located at a side opposite to the first side surface, a repulsive force between the magnet and the magnetic body may be required. That is, for the pressing force to the ball, the generation of a repulsive force between the bobbin (or the lens assembly) and the housing on the first side surface can be effective. The repulsive force to be described below can effectively press the lens assembly 12220 toward the ball B.

The second housing side portion 1232 may include the coil accommodation hole 1232h and the magnetic body grooves 1232g1 and 1232g2. In the housing 1230, the coil accommodation hole 1232h and the magnetic body grooves 1232g1 and 1232g2 may be located to face the guide groove G.

A coil 1251 may be located at the coil accommodation hole 1232h. In addition, the magnetic body grooves 1232g1 and 1232g2 may be provided as one or more magnetic body grooves. For example, the magnetic body grooves 1232g1 and 1232g2 may include a first magnetic body groove 1232g1 and a second magnetic body groove 1232g2.

The first magnetic body groove 1232g1 and the second magnetic body groove 1232g2 may be disposed to be spaced apart from each other in the optical axis direction. In addition, the first magnetic body groove 1232g1 and the second magnetic body groove 1232g2 may overlap each other in the optical axis direction. With this configuration, when the repulsive force generated between the magnetic body 1240 and the magnet 1252 is applied to the lens assembly 1220, a change in the tilting or decentering of the lens assembly 1220 can be suppressed. That is, it is possible to increase driving accuracy. In addition, the repulsive force can be generated as a holding force by the magnet and the magnetic body for driving without a separate magnet or yoke. With this configuration, it is possible to achieve lightweight of the second camera actuator.

In addition, the first magnetic body groove 1232g1 and the second magnetic body groove 1232g2 may be located at an outer surface 1232OS of the second housing side portion 1232. Accordingly, the first magnetic body groove 1232g1 and the second magnetic body groove 1232g2 may be disposed to be spaced apart from the magnetic body 1240 in the horizontal direction. In addition, the first magnetic body groove 1232g1 and the second magnetic body groove 1232g2 may overlap the coil accommodation hole 1232h in the optical axis direction or the third direction. With this configuration, the magnetic body 1240 may be spaced apart from the coil 1251 in the optical axis direction and may superpose (or overlap) the coil 1251 in the optical axis direction. A first magnetic body 1241 and a second magnetic body 1242 may superpose (or overlap) the coil 1251 in the optical axis direction. In addition, the first magnetic body 1241, the second magnetic body 1242, and the coil 1251 may be disposed on the substrate 1270. In addition, the first magnetic body 1241, the second magnetic body 1242, and the coil 1251 may be located at an inner surface of the substrate 1270 or on the same surface as the substrate 1270. In addition, at least a portion of the second housing side portion 1232 may be located between the first magnetic body groove 1232g1 (or the second magnetic body groove 1232g2) and the magnet 1252. Accordingly, the magnitude of the repulsive force applied to the lens assembly 1220 may be adjusted. That is, by applying an appropriate repulsive force to the lens assembly 1220, the consumption of a current required for driving the lens assembly can be efficiently controlled.

As another example, the first magnetic body groove 1232g1 and the second magnetic body groove 1232g2 may be located at the inner surface of the second housing side portion 1232. For example, the first magnetic body groove 1232g1 and the second magnetic body groove 1232g2 may be located at the inner surface facing the outer surface 1232OS of the second housing side portion 1232. Accordingly, it is possible to decrease the size of the magnetic body 1240 while maintaining the repulsive force, thereby achieving the lightweight of the second camera actuator.

For example, the first magnetic body groove 1232g1 and the second magnetic body groove 1232g2 may be formed as a groove or a recess. Accordingly, the first magnetic body 1241 and the second magnetic body 1242 may be located at the outer surface 1232OS or the inner surface of the second housing side portion 1232 according to an assembly direction.

As another example, the first magnetic body groove 1232g1 and the second magnetic body groove 1232g2 may include holes. Accordingly, the arrangement of the magnetic body 1240 in the first magnetic body groove 1232g1 and the second magnetic body groove 1232g2 can be freely performed. Accordingly, it is possible to facilitate assembly between the components in the second camera actuator (increase in assembly direction). In addition, a horizontal separation distance between the magnetic body 1240 and the magnet 1252 can also be easily adjusted.

Furthermore, the coil accommodation hole 1232h may be located between the first magnetic body groove 1232g1 and the second magnetic body groove 1232g2. The coil accommodation hole 1232h may overlap the first magnetic body groove 1232g1 and the second magnetic body groove 1232g2 in the optical axis direction. The coil 1251 may be located at the coil accommodation hole 1232h. In addition, the coil 1251 may be coupled to the substrate 1270 disposed outside the housing 1230. The coil 1251 may be electrically connected to the substrate 1270.

The coil accommodation hole 1232h may overlap the first magnetic body groove 1232g1 and the second magnetic body groove 1232g2 in the optical axis direction. Accordingly, a repulsive force close to a driving force may be generated. Accordingly, it is possible to suppress tilting of the lens assembly 1220, thereby increasing driving accuracy and generating the holding force of the lens assembly 1220 in a balanced manner.

In addition, the outer surface of the housing 1230 may be disposed on or may be in contact with the substrate. For example, the outer surface 1232OS of the second housing side portion 1232 may be located at the substrate 170. Alternatively, the outer surface 1232OS of the second housing side portion 1232 may be in contact with the substrate 170.

Referring again to FIG. 7, the lens assembly 1220 may be located at the housing 1230 and move in the optical axis direction. The second camera actuator 1200 may be an actuator that performs a fixed zoom or continuous zoom function. For example, the second camera actuator may be an actuator that performs a fixed zoom. The following description will be given based on the above description.

In addition, the lens assembly 1220 may include an accommodation hole 1220h that accommodates a lens group. At least one lens may be disposed in the accommodation hole 1220h. In addition, the accommodation hole 1220h may be located at a path of light of which path has been changed or reflected light in the first camera actuator. For example, the accommodation hole 1220h or the lens group may overlap the above optical member in the optical axis direction or the third direction (the Z-axis direction).

The lens assembly 1220 may include the first side surface 1221 and the second side surface 1222. The first side surface 1221 and the second side surface 1222 may face each other in the lens assembly 1220. The first side surface 1221 and the second side surface 1222 may be disposed to be spaced apart from each other in the second direction. Furthermore, the first side surface 1221 and the second side surface 1222 may be symmetrical with respect to the optical axis. In addition, the first side surface 1221 and the second side surface 1222 may be outer surfaces of the lens assembly 1220. The first side surface 1221 and the second side surface 1222 may overlap each other in the horizontal direction. The first side surface 1221 and the second side surface 1222 may be located to be opposite to each other with respect to the accommodation hole 1220h in a direction perpendicular to the optical axis direction (e.g., the horizontal direction). For example, the first side surface 1221 and the second side surface 1222 may be located to face each other with respect to the accommodation hole 1220h in the direction perpendicular to the optical axis direction (e.g., the horizontal direction).

A magnet and a ball may be disposed on the outer surface of the lens assembly 1220.

The magnet may be disposed on one side surface of the lens assembly 1220 or the bobbin, and the balls may be disposed on the other side surface. For example, the magnet 1252 may be disposed on the first side surface 1221. The balls B may be disposed on the second side surface 1222.

In addition, the second side surface 1222 may face the inner side surface 1231IS of the first housing side portion 1231. The first side surface 1221 may face the inner surface of the second housing side portion 1232.

A seating groove 1221h may be located at the first side surface 1221. The seating groove 1221h may be a “magnet groove.” Alternatively, the seating groove 1221 may be a “first groove.” The magnet 1252 may be disposed in the seating groove 1221h. In addition, the magnet 1252 may be disposed (or accommodated) in the first groove or magnet groove of the first side surface 1221. The seating groove 1221h may face the coil accommodation hole 1232h and the magnetic body grooves 1232g1 and 1232g2. The seating groove 1221h may overlap the coil accommodation hole 1232h and the magnetic body grooves 1232g1 and 1232g2 in the horizontal direction.

In addition, the recess 1222h may be disposed in the second side surface 1222. The recess 1222h may be provided as a single recess or a plurality of recesses. The recess 1222h may be located to correspond to the guide groove G. The recess 1222h may be located to face the guide groove G. In addition, the ball B may be located between the recess 1222h and the guide groove G. The guide groove G may be a “second groove.” That is, the recess 1222h may superpose (or overlap) the guide groove G in the horizontal direction.

In addition, the lens assembly 1220 may be provided as one or more lens assemblies. In addition, the lens assembly may move 2 mm to 12 mm.

Referring again to FIG. 8, the magnetic body 1240 may be disposed in the housing 1230. The magnetic body 1240 may be disposed in the magnetic body grooves 1232g1 and 1232g2. The magnetic body 1240 may be disposed at a location corresponding to the magnet 1252. For example, the magnetic body 1240 may be located to correspond to a path along which the magnet 1252 moves in the optical axis direction. The magnetic body 1240 may include the first magnetic body 1241 and the second magnetic body 1242 disposed to be spaced apart from each other in the optical axis direction. The first magnetic body 1241 and the second magnetic body 1242 may be disposed sequentially in the optical axis direction.

The first magnetic body 1241 and the second magnetic body 1242 may be located at the first magnetic body groove 1232g1 and the second magnetic body groove 1232g2, respectively.

The coil 1251 may be located between the first magnetic body 1241 and the second magnetic body 1242.

The first magnetic body 1241 and the second magnetic body 1242 may be disposed to be spaced a predetermined distance from the coil 1251. In addition, the first magnetic body 1241 and the second magnetic body 1242 may be located at both sides of the coil 1251 parallel to the movement path of the lens assembly.

Accordingly, when the lens assembly 1220 is moved in the optical axis direction by the coil 1251 and the magnet 1252, the lens assembly 1220 may be pressed by the repulsive force of the magnetic body 1240 and the magnet 1252. More specifically, the bobbin or the lens assembly 1220 may be pressed by the repulsive force of the magnetic body 1240 and the magnet 1252 in a direction from the first side surface to the second side surface perpendicular to the optical axis direction. The repulsive force may correspond to the holding force. That is, the movement of the lens assembly 1220 can be maintained at a location corresponding to a predetermined height without tilted to one side within the housing 1230. That is, the first magnetic body 1241 and the second magnetic body 1242 may generate the repulsive force with the magnet 1252 so that the attitude of the lens assembly can be maintained to prevent the lens assembly from being tilted to one side or departing from the movement path even when the lens assembly moves.

The driving unit 1250 may include the coil 1251, the magnet 1252, and the position sensor 1253. The coil 1251 and the magnet 1252 generate an electromagnetic force to move the lens assembly 1220.

The magnet 1252 may be disposed in the seating groove 1221h of the lens assembly 1220. Furthermore, the coil 1251 may be located to face the magnet 1252. Accordingly, the above electromagnetic force may be generated by the current flowing in the coil 1251. Even when the lens assembly 1220 moves, one area of the magnet 1252 may superpose (or overlap) the coil 1251 in the horizontal direction. That is, the coil 1251 may superpose or overlap the magnetic body 1240 in the horizontal direction. Accordingly, it is possible to increase driving efficiency.

Furthermore, even when the lens assembly 1220 moves, at least one area of the magnet 1252 may overlap the magnetic body 1240 in the horizontal direction. Accordingly, even when the lens assembly 1220 moves, the repulsive force may press the lens assembly 1220 toward the ball B, thereby generating a driving holding force. That is, the ball B between the second side surface 1222 of the lens assembly 1220 and the housing 1230 may be pressed by the repulsive force of the magnetic body 1240 and the magnet 1252. In addition, the coil 1251 may be disposed on the substrate 1270 and electrically connected to the substrate 1270. In addition, the first magnetic body 1241 and the second magnetic body 1242 may be disposed to be spaced apart from each other in the optical axis direction with respect to the coil 1251. For example, at least a portion of the coil 1251 may be disposed between the first magnetic body 1241 and the second magnetic body 1242. The first magnetic body 1241 and the second magnetic body 1242 may be located adjacent to the substrate 1270.

Furthermore, the position sensor 1253 may be provided as one or more position sensors. The position sensor 1253 may include a Hall sensor. The position sensor 1253 may be located within the coil 1251. In addition, the position sensor 1253 may be disposed on the substrate 1270 and electrically connected to the substrate 1270.

Since the magnet 1252 is disposed on the lens assembly 1220, the magnet 1252 may be disposed to be spaced apart from the coil 1251 in the horizontal direction. In addition, the magnet 1252 may be disposed to be spaced apart from the magnetic body 1240 in the horizontal direction.

In addition, a length of the coil 1251 in the horizontal direction may be greater than a length of the magnetic body in the horizontal direction (the second direction Y). Accordingly, the horizontal separation distance between the coil 1251 and the magnet 1252 may be smaller than the horizontal separation distance between the magnetic body and the magnet 1252. Accordingly, it is possible to increase the driving force by increasing the electromagnetic force.

In addition, in the embodiment, the magnet 1252 may include a first area PA1, a neutral area NA, and a second area PA2 disposed sequentially in the optical axis direction.

The first area PA1 and the second area PA2 may have poles. The first area PA1 may be located adjacent to the first magnetic body 1241. The second area PA2 may be disposed adjacent to the second magnetic body 1242. The above repulsive force may be generated by the first area PA1 of the magnet 1252 and the first magnetic body 1241. In addition, the above repulsive force may be generated by the second area PA2 of the magnet 1252 and the second magnetic body 1242.

In an embodiment, a coil, a first magnetic body, and a second magnetic body may be disposed on one side portion of the housing. In addition, balls may be disposed on the other side portion. In this case, the one side portion may correspond to the second housing side portion. In addition, the other side portion may correspond to the first housing side portion. In addition, the second housing side portion, which is one side portion, may face one side surface (the first side surface) of the above bobbin.

In addition, the balls B may be disposed between the housing 1230 and the lens assembly 1220. In particular, the ball B may be disposed in the guide groove G disposed in the inner surface 1231IS of the first housing side portion 1231. In addition, the ball B may be located at the recess 12222h of the lens assembly. In addition, the ball B may be disposed on the second side surface of the lens assembly. Accordingly, the ball B may be located between the recess 1222h of the lens assembly and the guide groove G of the housing 1230. The balls B may include all of a rolling member, a rolling body, a ball, etc.

The driving unit 1250 according to the embodiment may be located at one side surface or one side portion of the housing 1230. For example, the driving unit 1250 may be located at the second housing side portion 1232. With this configuration, electrical connection with the substrate can be easy, and design or testing of electrical control signals can be easily performed.

The base part 1260 may be located behind the housing 1230. The base part 1260 may be located between the lens assembly 1220 and the image sensor in the circuit board. A component, such as a filter, may be fixed to the base part 1260. In addition, the base part 1260 may be disposed to surround the image sensor. With this configuration, since the image sensor is free from foreign substances, it is possible to improve the reliability of the element. However, the following description without the base part 1260 will be given in some drawings.

The substrate 1270 may be located at the outer surface of the housing 1230. The substrate 1270 may be a plate extending in the optical axis direction. Alternatively, the substrate 1270 may have a bent portion according to a structure. The substrate 1270 may include a flexible printed circuit board, a flexible-rigid printed circuit board, a rigid printed circuit board.

In addition, the substrate 1270 may be coupled to the housing 1230 and electrically connected to the coil 1251 and the position sensor 1253. Furthermore, a control unit (e.g., a driver IC) may be located at the substrate 1270.

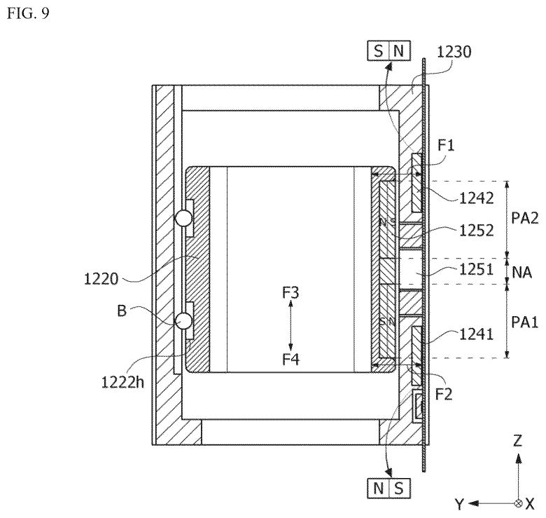

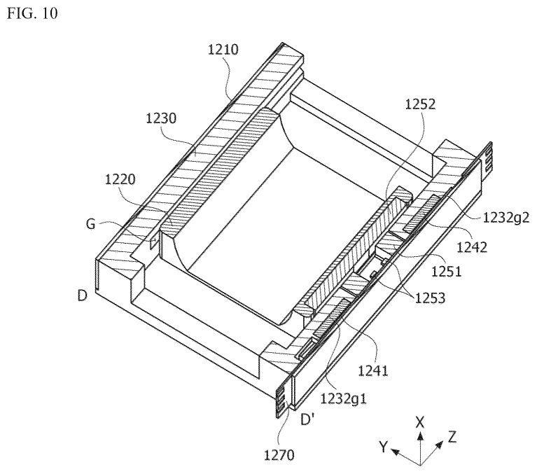

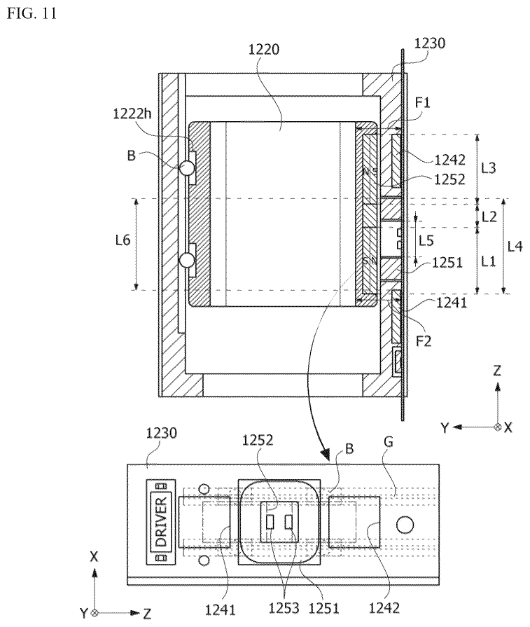

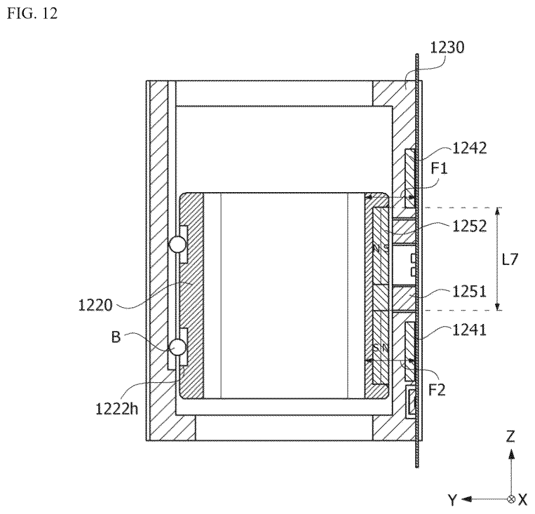

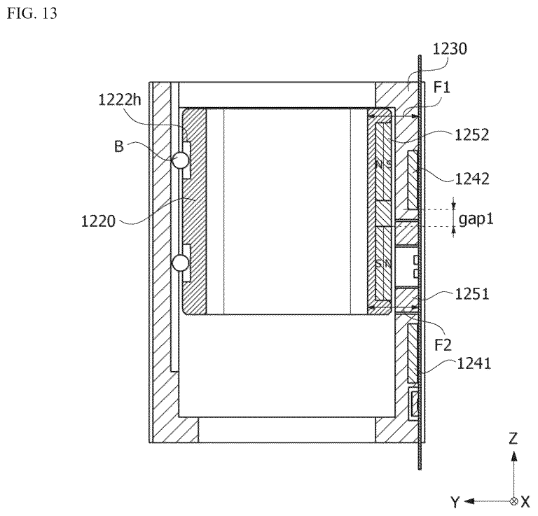

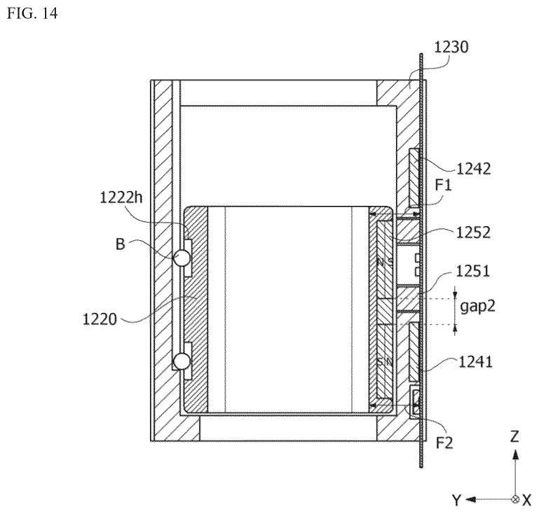

FIG. 9 is a view along line DD′ in FIG. 4, FIG. 10 is a perspective view of FIG. 9, FIG. 11 is a view of a lens assembly disposed at a specific location in the second camera actuator according to the embodiment, FIG. 12 is a view of a lens assembly disposed at another specific location in the second camera actuator according to the embodiment, FIG. 13 is a view of a lens assembly disposed in a first state in the second camera actuator according to the embodiment, and FIG. 14 is a view of a lens assembly disposed in a second state in the second camera actuator according to the embodiment.

Referring to FIGS. 9 and 10, the magnetic body may include the first magnetic body 1241 adjacent to the first area PA1 and the second magnetic body 1242 adjacent to the second area PA2. Accordingly, the first area PA1 and the second area PA2 may be disposed sequentially in the optical axis direction.

In addition, the pole of an outer surface in the first area PA1 and the pole of an inner surface of the first magnetic body 1241 may be the same. When the pole of the outer surface in the first area PA1 is an N pole (or an S pole), the pole of the inner surface of the first magnetic body 1241 may be an N pole (or an S pole).

In addition, when the pole of the outer surface in the second area PA2 is an N pole (or an S pole), the pole of an inner surface of the second magnetic body 1242 may be an N pole (or an S pole).

The first magnetic body and the second magnetic body may be disposed as unipolar magnets. In addition, the magnets may be disposed as bipolar magnets or unipolar magnets.

That is, the magnetic body according to the embodiment may have the same pole as one area of an adjacent magnet. In addition, even in the movement of the magnet 1252 according to the lens assembly 1220, the poles of facing surfaces between the magnetic body and the magnet may be the same. For example, one surface of at least one area of the magnet and one surface of the magnetic body may face each other and have the same pole. Accordingly, the above repulsive force may be generated. In an embodiment, one surface (e.g., the outer surface) of the magnet 1252 and one surface (e.g., the inner surface) of the magnetic body adjacent to the outer surface of the magnet may face each other and have the same pole. For example, an outer surface of the first area PA1 of the magnet 1252 may have the same pole as the inner surface of the first magnetic body 1241. In addition, an outer surface of the second area PA2 of the magnet 1252 may have the same pole as the inner surface of the second magnetic body 1242.

In addition, the pole of the inner surface of the first magnetic body 1241 may be the pole opposite to the pole of the outer surface of the second area PA2. In addition, the pole of the outer surface of the first area PA1 may correspond to (or may be the same as) the pole of the outer surface of the second area PA2.

Accordingly, when the lens assembly is moved in the optical axis direction by electromagnetic forces F3 and F4, the lens assembly can accurately move along the guide groove without separated from the guide groove.

Referring again to FIGS. 11 and 12, a length L1 of the first area PA1 in the optical axis direction may correspond to (may be the same as) a length L3 of the second area PA2 in the optical axis direction. The length L1 of the first area PA1 or the length L3 of the second area PA2 in the optical axis direction may be greater than a length L2 of the neutral area NA in the optical axis direction. With this configuration, a long stroke can be implemented through the magnet 1252 and the driving force can be increased.

A length L4 from the first magnetic body 1241 to the outer side of the coil 1251 may correspond to a length L6 of the first area PA1 and the neutral area NA in the optical axis direction. The length L4 from the first magnetic body 1241 to the outer side of the coil 1251 may correspond to the length L6 or less of the first area PA1 and the neutral area NA in the optical axis direction. With this configuration, it is possible to suppress the generation of a counter electromotive force by the coil 1251. That is, it is possible to increase driving efficiency.

In addition, the length L4 from the first magnetic body 1241 to the outer side of the coil 1251 may correspond to the sum of a gap between the first magnetic body 1241 and the coil 1251 and the length of the coil 1251.

A length L7 from the second magnetic body 1242 to the outer side of the coil 1251 may correspond to the length L6 of the first area PA1 (or the second area) and the neutral area NA in the optical axis direction. The length L7 from the second magnetic body 1242 to the outer side of the coil 1251 may be smaller than or equal to the length L6 of the first area PA1 (or the second area) and the neutral area NA in the optical axis direction. With this configuration, it is possible to suppress the generation of a counter electromotive force by the coil 1251. That is, it is possible to increase driving efficiency. In addition, the length L7 from the second magnetic body 1242 to the outer side of the coil 1251 may correspond to the sum of a gap between the second magnetic body 1242 and the coil 1251 and the length of the coil 1251.

In addition, the coil 1251 may include a coil hole located at a central area thereof. The coil hole may be a portion formed by winding the coil. The length L5 of the coil hole may be greater than the length L2 of the neutral area NA. Accordingly, it is possible to increase the generation efficiency of the counter electromotive force by the coil and the first area PA1 and the second area PA2.

The length L1 of the first area PA1 or the length L3 of the second area PA2 may be smaller than the length of the coil 1251. In addition, the sum of the length L1 (or L3) of the first area PA1 (or the second area PA2) and the length L2 of the neutral area NA may be greater than the length of the coil. Accordingly, it is possible to effectively suppress the generation of the above counter electromotive force.

In addition, in tele or wide, the neutral area NA may horizontally superpose (or overlap) one of the magnetic bodies 1241 and 1242.

In the first state or the tele, the lens assembly 1220 may move to one side as much as possible. For example, in the first state or the tele, the lens assembly 1220 may be closest to the first camera actuator or may move in the direction opposite to the optical axis as much as possible.

In the second state or the wide, the lens assembly 1220 may move to the other side as much as possible. For example, in the second state or the wide, the lens assembly 1220 may be closest to the image sensor or may move in the optical axis direction as much as possible.

In the first state (tele) or the second state (wide), the neutral area NA may superpose (or overlap) the magnetic bodies 1241 and 1242, thereby suppressing an attraction force generated by other magnetic bodies as much as possible. That is, repulsive forces F1 and F2 can efficiently press the lens assembly. At this time, a first repulsive force F1 is a force generated between the second magnetic body 1242 and the magnet (e.g., the second area). A second repulsive force F2 is a force generated between the first magnetic body 1241 and the magnet (e.g., the first area).

Referring again to FIGS. 13 and 14, in the second camera actuator according to the embodiment, the first magnetic body 1241 may not superpose (or overlap) the second area PA2 in the horizontal direction in the first state or the tele. The first magnetic body 1241 may be disposed to be misaligned with the second area PA2. That is, the first magnetic body 1241 may be disposed to be spaced a predetermined distance gap2 from the second area PA2 in the optical axis direction. In addition, in the second camera actuator according to the embodiment, the second magnetic body 1242 may not superpose (or overlap) the first area PA1 in the horizontal direction in the second state or the wide. The second magnetic body 1242 may be disposed to be misaligned with the first area PA1. That is, the second magnetic body 1242 may be disposed to be spaced a predetermined distance gap1 from the first area PA1 in the optical axis direction.

In the first state or the second state, the neutral area NA may horizontally superpose (or overlap) the coil 1251 and at least one of the magnetic bodies 1241 and 1242. Accordingly, the first area PA1 and the second area PA2 may face current areas flowing in different directions in the coil 1251. Alternatively, one of the first area PA1 and the second area PA2 may face one area of the coil 1251.

In addition, one of the first area PA1 and the second area PA2 may face one (e.g., the first magnetic body or the second magnetic body) of the magnetic bodies. Accordingly, it is possible to prevent the generation of the counter electromotive force even in the maximum movement state. Accordingly, it is possible to further increase driving efficiency.

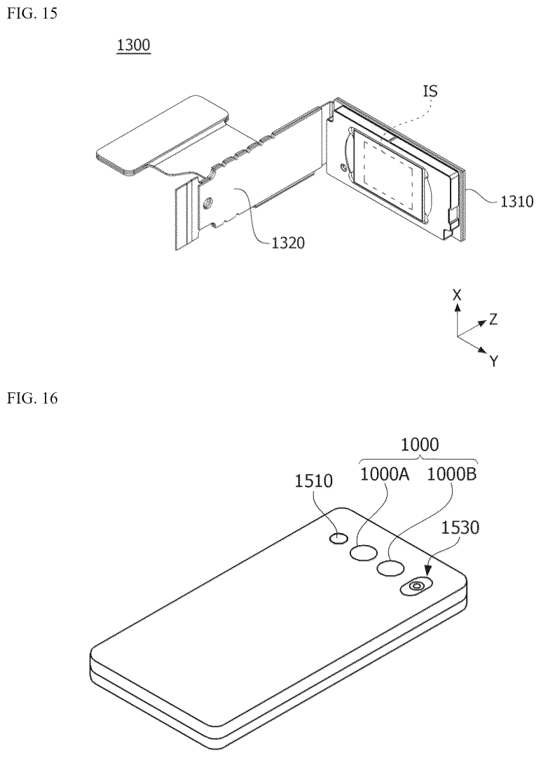

FIG. 15 is a schematic view illustrating a circuit board according to the embodiment.

Referring to FIG. 15, as described above, the circuit board 1300 according to the embodiment may include a first circuit board 1310 and a second circuit board 1320. The first circuit board 1310 may be located under the base and coupled to the base. In addition, the image sensor IS may be disposed on the first circuit board 1310. In addition, the first circuit board 1310 and the image sensor IS may be electrically connected. That is, the base may be located at the rear end of the second camera actuator, and the image sensor and the circuit board (first circuit board part) may be located at the rear end of the base. The base may include a filter (e.g., infrared rays). The circuit board 1300 may include the image sensor and a sensor base.

In addition, the second circuit board 1320 may be located at a side portion of the base. In particular, the second circuit board 1320 may be located at a first side portion of the base. Accordingly, the second circuit board 1320 may be located adjacent to the coil located adjacent to the first side portion, thus an electrical connection can be easy. In addition, the second circuit board 1320 may be located at the second side portion. As described above, the second circuit board 1320 may be provided as a plurality of second circuit boards. However, the embodiments of the present invention are not limited thereto, and the second circuit board 1320 may be disposed on only one of the first side portion and the second side portion.

Furthermore, the circuit board 1300 may further include a fixed board (not illustrated) located at a side surface thereof. Accordingly, even when the circuit board 1300 is formed of a flexible material, the circuit board 1300 may be coupled to the base while maintaining stiffness by the fixed board.

The second circuit board 1320 of the circuit board 1300 may be positioned on the side portion of the driving unit 1250. The circuit board 1300 may be electrically connected to the first driving part and the driving part. For example, electrical connection may be made by a surface mounting technology (SMT). However, the embodiments of the present invention are not limited to such a method.

The circuit board 1300 may include a circuit board having line patterns that may be electrically connected, such as a rigid printed circuit board (PCB), a flexible PCB, a rigid-flexible PCB, etc. However, the embodiments of the present invention are not limited to these types.

In addition, the circuit board 1300 may be electrically connected to another camera module in the terminal or a processor of the terminal. Accordingly, the above camera actuator and camera module including the same may transmit and receive any signal in the terminal.

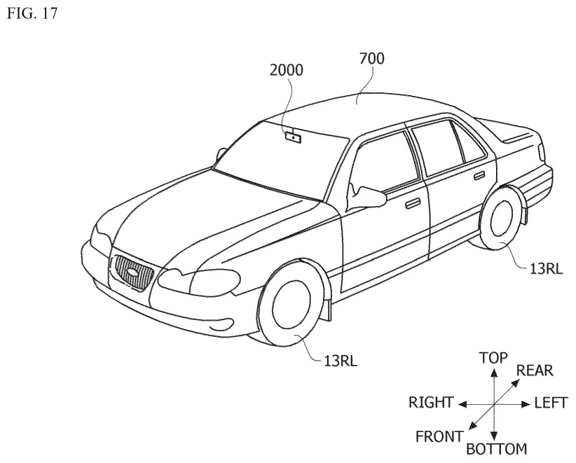

FIG. 16 is a perspective view of a mobile terminal to which the camera module according to the embodiment is applied.

As illustrated in FIG. 16, a mobile terminal 1500 of the embodiment may include a camera module 1000, a flash module 1530, and an AF device 1510, which are provided on a rear surface thereof.

The camera module 1000 may include an image capturing function and an AF function. For example, the camera module 1000 may include the AF function using an image.

The camera module 1000 processes an image frame of a still image or a moving image obtained by an image sensor in a capturing mode or a video call mode.

The processed image frame may be displayed on a predetermined display and stored in a memory. A camera (not illustrated) may also be disposed on a front surface of a body of the mobile terminal.

For example, the camera module 1000 may include a first camera module 1000A and a second camera module 1000B, and the first camera module 1000A may implement an OIS function along with an AF or zooming function.

The flash module 1530 may include a light-emitting element for emitting light therein. The flash module 1530 may be operated by a camera operation of the mobile terminal or a user's control.

The AF device 1510 may include one of a package of a surface light-emitting laser element as a light-emitting part.

The AF device 1510 may include the AF function using a laser. The AF device 1510 may be mainly used in a condition that the AF function using the image of the camera module 1000 is degraded, for example, a proximity of 10 m or less or dark environment.

The AF device 1510 may include a light-emitting part including a vertical cavity surface emitting laser (VCSEL) semiconductor device and a light-receiving part for converting light energy into electrical energy, such as a photodiode.

FIG. 17 is a perspective view of a vehicle to which the camera module according to the embodiment is applied.

For example, FIG. 17 is an external view of the vehicle including a vehicle driving assistance device to which the camera module 1000 according to the embodiment is applied.

Referring to FIG. 17, a vehicle 700 according to the embodiment may include wheels 13FL and 13FR rotated by a power source and a predetermined sensor. Although the sensor may be a camera sensor 2000, the present invention is not limited thereto.

The camera 2000 may be a camera sensor to which the camera module 1000 according to the embodiment is applied. The vehicle 700 according to the embodiment may acquire image information through the camera sensor 2000 for capturing a forward image or a surrounding image, determine a situation in which a lane is not identified using the image information, and generate a virtual lane when the lane is not identified.

For example, the camera sensor 2000 may acquire a forward image by capturing a forward view of the vehicle 700, and a processor (not illustrated) may acquire image information by analyzing an object included in the forward image.

For example, when a lane, a nearby vehicle, a traveling obstacle, and objects, such as a median, a curb, or a tree corresponding to an indirect road mark, are captured in the image captured by the camera sensor 2000, the processor may detect the object and include the detected object in the image information. At this time, the processor may further supplement the image information by acquiring distance information to the object detected through the camera sensor 2000.

The image information may be information about the object captured in the image. The camera sensor 2000 may include an image sensor and an image processing module.

The camera sensor 2000 may process still images or moving images obtained by the image sensor (e.g., a complementary metal-oxide semiconductor (CMOS) or a charge-coupled device (CCD)).

The image processing module may process the still images or moving images acquired through the image sensor to extract necessary information, and transmit the extracted information to the processor.

In this case, although the camera sensor 2000 may include a stereo camera for improving the measurement accuracy of the object and further securing information such as a distance between the vehicle 700 and the object, the present invention is not limited thereto.

Although embodiments have been mainly described above, these embodiments are only illustrative and do not limit the present invention, and those skilled in the art to which the present invention pertains can know that various modifications and applications that are not exemplified above are possible without departing from the essential characteristics of the embodiments. For example, each component specifically shown in the embodiments may be implemented by modification thereof. In addition, differences related to these modifications and applications should be construed as being included in the scope of the present invention defined in the appended claims.

1-10. (canceled)

11. A camera actuator comprising:
a housing;
a bobbin that moves in an optical axis direction within the housing and includes an accommodation bole and a first side surface and a second side surface disposed opposite to each other with respect to the accommodation hole in a direction perpendicular to the optical axis direction;
a driving unit that includes a magnet disposed on the first side surface of the bobbin and a coil facing the magnet and moves the bobbin;
a magnetic body disposed in the housing and disposed at a location corresponding to the magnet; and
a ball disposed on the second side surface of the bobbin,
wherein the ball is pressed between the second side surface of the bobbin and the housing by a repulsive force generated by the magnetic body and the magnet.

12. The camera actuator of claim 11, wherein the magnet is accommodated in a first groove of the first side surface,
wherein the ball is accommodated in a second groove of the second side surface, and
wherein the first groove overlaps the second groove in a direction perpendicular to the optical axis direction.

13. The camera actuator of claim 11, wherein the housing includes a first housing side portion and a second housing side portion opposite to the first housing side portion,
wherein an inner surface of the first housing side portion faces the second side surface, and
wherein an inner surface of the second housing side portion faces the first side surface.

14. The camera actuator of claim 13, wherein the housing includes a guide groove disposed in the inner surface of the first housing side portion, and
wherein the ball is disposed in the guide groove.

15. The camera actuator of claim 13, wherein the second housing side portion includes a coil accommodation hole and a magnetic body groove disposed to be spaced apart from the coil accommodation hole in the optical axis direction, and
wherein the magnetic body is disposed in the magnetic body groove.

16. The camera actuator of claim 15, wherein the magnetic body groove is disposed in an outer surface of the second housing side portion.

17. The camera actuator of claim 11, wherein the magnet includes a first area, a neutral area, and a second area disposed sequentially in the optical axis direction.

18. The camera actuator of claim 17, wherein the magnetic body includes a first magnetic body adjacent to the first area and a second magnetic body adjacent to the second area.

19. The camera actuator of claim 18, wherein a pole of an outer surface of the first area and a pole of an inner surface of the first magnetic body are the same, and
wherein a pole of an outer surface of the second area and a pole of an inner surface of the second magnetic body are the same.

20. The camera actuator of claim 18, wherein the coil is disposed between the first magnetic body and the second magnetic body.

21. The camera actuator of claim 17, wherein the coil includes a coil hole, and a length of the coil hole is greater than a length of the neutral area.

22. The camera actuator of claim 17, wherein a length of the first area or the second area is smaller than a length of the coil.

23. The camera actuator of claim 18, wherein the neutral area overlaps one of the magnetic bodies in a direction perpendicular to the optical axis direction.

24. The camera actuator of claim 18, wherein when the magnet is moved to one side as much as possible, the first magnetic body does not overlap the second area in a direction perpendicular to the optical axis direction.

25. The camera actuator of claim 24, wherein when the magnet is moved to the other side as much as possible, the second magnetic body does not overlap the first area in a direction perpendicular to the optical axis direction.

26. The camera actuator of claim 11, wherein the magnetic body is spaced apart from the coil in the optical axis direction, and the magnetic body overlaps the coil in the optical axis direction.

27. The camera actuator of claim 11, wherein the bobbin is pressed by a repulsive force generated by the magnetic body and the magnet in a direction from the first side surface toward the second side surface perpendicular to the optical axis direction.

28. A camera actuator comprising:
a housing;
a bobbin disposed in the housing and including a first side surface and a second side surface disposed opposite to each other;
a driving unit that includes a coil and a magnet facing each other in one direction perpendicular to an optical axis direction and moves the bobbin in the optical axis direction;
a magnetic body disposed in the housing and overlapping at least one area of the magnet in the one direction, and
a ball disposed between the housing and the first side surface of the bobbin,
wherein the magnet is disposed on the second side surface of the bobbin, and the ball is disposed to overlap the magnet in the one direction.

29. The camera actuator of claim 28, wherein one surface of the at least one area of the magnet and one surface of the magnetic body faces each other and have the same pole.

30. A camera actuator comprising:
a housing;
a bobbin disposed in the housing;
a driving unit that includes a coil and a magnet and moves the bobbin in an optical axis direction;
a ball disposed between the housing and the bobbin, and
a first magnetic body and a second magnetic body disposed in the housing, generates a repulsive force with the magnet, and spaced apart from each other in the optical axis direction,
wherein the magnet is disposed on one surface of the bobbin, the coil, the first magnetic body, and the second magnetic body are disposed on one side portion of the housing facing the one side surface, and
wherein at least a portion of the coil is disposed between the first magnetic body and the second magnetic body.
